(19) United States
(12) Patent Application Publication
(10) Pub. No.: US 2024/0380216 A1
(43) Pub. Date: Nov. 14, 2024

(54) INTEGRATED BUILDING DESIGN, CONSTRUCTION, AND OPERATING SYSTEM USING FAULT MANAGED MICROGRID

(71) Applicant: Sinclair Digital Services, Inc., Fort Worth, TX (US)

(72) Inventors: Luis Suau, Fort Lauderdale, FL (US); Hanna Walker, Fort Worth, TX (US); Farukh Aslam, Fort Worth, TX (US)

(73) Assignee: Sinclair Digital Services, Inc., Fort Worth, TX (US)

(21) Appl. No.: 18/661,665

(22) Filed: May 12, 2024

Related U.S. Application Data
(60) Provisional application No. 63/501,838, filed on May 12, 2023.

(51) Int. Cl. H02J 3/46; H02J 3/00

(52) U.S. Cl. CPC H02J 3/46; H02J 3/001; H02J 3/007; H02J 2203/10

(57) ABSTRACT

An integrated building design, control, and operation system using a high efficiency fault managed power microgrid that includes a first tier building power converter system that receives input power from one or more primary power sources and converts the received primary power into one or more fault managed power outputs; a plurality of loads, where each load is coupled to receive one of the fault managed power outputs; and a main building controller in communication with the first tier building converter system and configured to control the operation of the first tier power converter to initiate the provision of fault managed power to the plurality of loads and/or to adjust the power level provided to such loads and/or to monitor the operating characteristics of the outputs

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

The present disclosure is directed to aspects of building design and construction and building operating systems. Conventionally buildings are constructed to utilize externally supplied AC power that is received at the building and distributed throughout the building to conventional plugs (receptacles) and/or through conventional switches to lighting and other outlets. Such conventional approaches are not optimum at least because they require the distribution of relatively high-voltage power throughout the building, which requires costly hardware, components and labor for installation and because it is difficult in such conventional systems to easily control the distribution of power to specific locations within the building (e.g., to a specific outlet or to only part of a specific room).

The contents of the specific disclosure are intended to overcome and/r address these, and other, limitations of known systems.

### BRIEF SUMMARY OF THE PRESENT INVENTIONS

A brief summary of the inventions indicating their nature and substance may be understood from the subject matter presented in the appended claims, which are incorporated herein by reference for all purposes of this summary, and by the inventions presented in any claims that may be issued from this application, which claims also are incorporated herein by reference for all purposes of this summary.

An integrated building design, control, and operation system using a high efficiency fault managed power microgrid comprising: a first tier building power converter system that receives input power from one or more primary power sources and converts the received primary power into one or more fault managed power outputs; a plurality of loads, each load coupled to receive one of the fault managed power outputs; and a main building controller in communication with the first tier building converter system and configured to control the operation of the first tier power converter to initiate the provision of fault managed power to the plurality of loads and/or to adjust the power level provided to such loads and/or to monitor the operating characteristics of the outputs; wherein at least one of the loads powered by one of the fault managed power outputs comprises a harness and one or more linked DC-AC converters that convert the provided fault managed power to AC power, were each DC-AC converter is associated with an AC outlet.

In a further embodiment, at least one of the fault manager power output is a low voltage DC output that can be transmitted using an Ethernet supporting cable without the need for a separate conduit structure.

In still further embodiments at least one of the loads is a television that receives power, data, control, and programming information through one of the fault managed power outputs and/or at least one of the loads includes an input module that receives fault managed power and converts the received power into a power form that may be stored in a battery module; and a battery module comprising one or more batteries for storing the converted power, wherein the battery is capable of providing a current output greater than the current output of the first tier building power converter system.

### BRIEF DESCRIPTION OF THE SEVERAL VIEWS OF THE DRAWINGS

The following figures form part of the disclosure of inventions and are included to demonstrate further certain aspects of the inventions. The inventions may be better understood by reference to one or more of these figures in combination with the detailed description of certain embodiments presented herein.

FIGS. 1A and 1B generally illustrate an exemplary embodiments of an integrated building design, control, and operation system using a high efficiency fault managed power microgrid.

FIG. 2 illustrates an example of an alternative television device 200, constructed in accordance with teachings of the present disclosure, suitable for use in a fault managed power microgrid as described herein.

FIG. 3 illustrates An exemplary low voltage DC power storage/converter constructed in accordance with certain teachings of the present disclosure.

FIG. 4 depicts a high level representation of a variable refrigerant flow (VFR) heating/cooling system constructed in accordance with certain teachings of the present disclosure that includes at least a compressor component and a fan/cooling component 404.

FIG. 5 illustrates certain operational aspects of an exemplary DCO Assistant as described herein.

FIG. 6 illustrates an exemplary embodiment of a DCO Assistant wherein an electrical engineer can receive plans previously provided to the DCO Assistant by an architect.

FIG. 7 illustrates an exemplary dashboard that can be provided by the DCO Assistant described herein that reflects options that a designer could select for double rooms in a hotel

FIGS. 8A and 8B illustrate an exemplary DCO Assistant configured to automatically identify new (or replaced) equipment, update the main controller's database to reflect such equipment and push the new equipment any configuration settings or drivers required for it to operate within the overall system.

FIG. 9 illustrates an exemplary programming interface that can be used in a hotel room or other location to automatically turn on a light in a room the first time (or at all times) a human is detected as entering the room (e.g., via a door sensor or a proximity sensor).

FIG. 10 illustrates control of a building to promote efficient use of the building, and/or to reduce power consumption and, therefore, power costs, through the designation of some or all of the rooms in a hotel as either being occupied or unoccupied and the implementation of control functionality based on that designation.

FIG. 11 illustrates a room specific monitoring dashboard that can be used to allow for immediate adjustment of the settings associated with a given room, such as lighting, shade, sound, television, settings, etc.,

FIG. 12 illustrates an exemplary interface that may be used to provide information of general management interest, such as whether there is an alert/alarm for a given room (e.g., service requested or an unresolved guest issue), the relative occupancy rate over a previous day/month/date by year, or specific room usage.

FIG. 13 illustrates an exemplary dashboard that may be used in a hotel to track and report on a variety of different metrics such as room uptime, energy consumption, energy usage by date, etc.

While the inventions disclosed herein are susceptible to various modifications and alternative forms, only a few specific embodiments have been shown by way of example in the drawings and are described in more detail below. The figures and detailed descriptions of these embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts illustrated and taught by the specific embodiments.

### DISCLOSURE

The Figures described above, and the written description of specific structures and functions below, are not presented to limit the scope of the inventions disclosed or the scope of the appended claims. Rather, the Figures and written description are provided to teach a person skilled in this art to make and use the inventions for which patent protection is sought.

A person of skill in this art having benefit of this disclosure will understand that the inventions are disclosed and taught herein by reference to specific embodiments, and that these specific embodiments are susceptible to numerous and various modifications and alternative forms without departing from the inventions we possess. For example, and not limitation, a person of skill in this art having benefit of this disclosure will understand that Figures and/or embodiments that use one or more common structures or elements, such as a structure or an element identified by a common reference number, are linked together for all purposes of supporting and enabling our inventions, and that such individual Figures or embodiments are not disparate disclosures. A person of skill in this art having benefit of this disclosure immediately will recognize and understand the various other embodiments of our inventions having one or more of the structures or elements illustrated and/or described in the various linked embodiments. In other words, not all possible embodiments of our inventions are described or illustrated in this application, and one or more of the claims to our inventions may not be directed to a specific, disclosed example. Nonetheless, a person of skill in this art having benefit of this disclosure will understand that the claims are fully supported by the entirety of this disclosure.

Those persons skilled in this art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

Further, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the scope of what is claimed

As used herein, fault managed power describes power that may be safely transmitted through the use of a system that monitors and reacts to the detection of faults or undesired system conditions at the source of the power through for example, halting the transmission of power in the event that a fault is detected. One example of fault managed power is power provided in accordance with the Class 4 UL classification published in Article 726 of the National Electric Code. In some applications fault managed power can be used in place or in conjunction with, power limited systems which limit power at the source rather than at a fault.

Fault managed power can exist in both high voltage and low voltage forms. In one form, fault managed power is provided through the provision of DC voltage pulses of either relatively high (or low) DC voltage value. In others, power is provided on a substantially continuous basis. Power over Ethernet and USB can be considered one form of low voltage DC fault managed power.

When implementing one or more of the inventions disclosed herein, any combination of one or more computer readable storage media may be used. A computer readable storage medium may be, for example, but not limitation, an electronic, magnetic, optical, electromagnetic, infrared, or semiconductor system, apparatus, or device, or any suitable combination of the foregoing. More specific, but non-limiting, examples of the computer readable storage medium may include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this disclosure, a computer readable storage medium may be any tangible medium that can contain or store a program for use by or in connection with an instruction execution system, apparatus, or device.

Computer program code for carrying out operations of one or more of the present inventions may be written in any combination of one or more programming languages, including an object-oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. The remote computer may be connected to the user's computer through any type of network, including a local area network (LAN) or a wide area network (WAN), or the connection may be made to an exterior computer for example, through the Internet using an Internet Service Provider.

Reference throughout this disclosure to “one embodiment,” “an embodiment,” or similar language means that a particular feature, structure, or characteristic described in connection with the embodiment is included in at least one of the many possible embodiments of the present inventions. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of one embodiment may be combined in any suitable manner in one or more other embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. Those of skill in the art having the benefit of this disclosure will understand that the inventions may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood by those of skill in the art that each block of the schematic flowchart diagrams and/or schematic block diagrams, and combinations of blocks in the schematic flowchart diagrams and/or schematic block diagrams, may be implemented by computer program instructions. Such computer program instructions may be provided to a processor of a general-purpose computer, special purpose computer, or other programmable data processing apparatus to create a machine or device, such that the instructions, which execute via the processor of the computer or other programmable data processing apparatus, structurally configured to implement the functions/acts specified in the schematic flowchart diagrams and/or schematic block diagrams block or blocks. These computer program instructions also may be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks. The computer program instructions also may be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and/or operation of possible apparatuses, systems, methods, and computer program products according to various embodiments of the present inventions. In this regard, each block in the schematic flowchart diagrams and/or schematic block diagrams may represent a module, segment, or portion of code, which comprises one or more executable instructions for implementing the specified logical function(s).

It also should be noted that, in some possible embodiments, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they do not limit the scope of the corresponding embodiments. Indeed, some arrows or other connectors may be used to indicate only the logical flow of the depicted embodiment. For example, but not limitation, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, may be implemented by special purpose hardware-based systems that perform the specified functions or acts, or combinations of special purpose hardware and computer instructions.

The description of elements in each Figure may refer to elements of proceeding Figures. Like numbers refer to like elements in all figures, including alternate embodiments of like elements. In some possible embodiments, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

As used herein, references to fault managed power (FMP) generally refer to all forms of fault managed power whether high or low voltage and, whether using voltage pulses or otherwise.

As used herein, references to a particular form of fault managed power, e.g., low voltage DC and/or POE and/or USB, should be understood as exemplary only and that an embodiment discussed in connection with one form of power (e.g., POE) can be implemented using an alternative form of power.

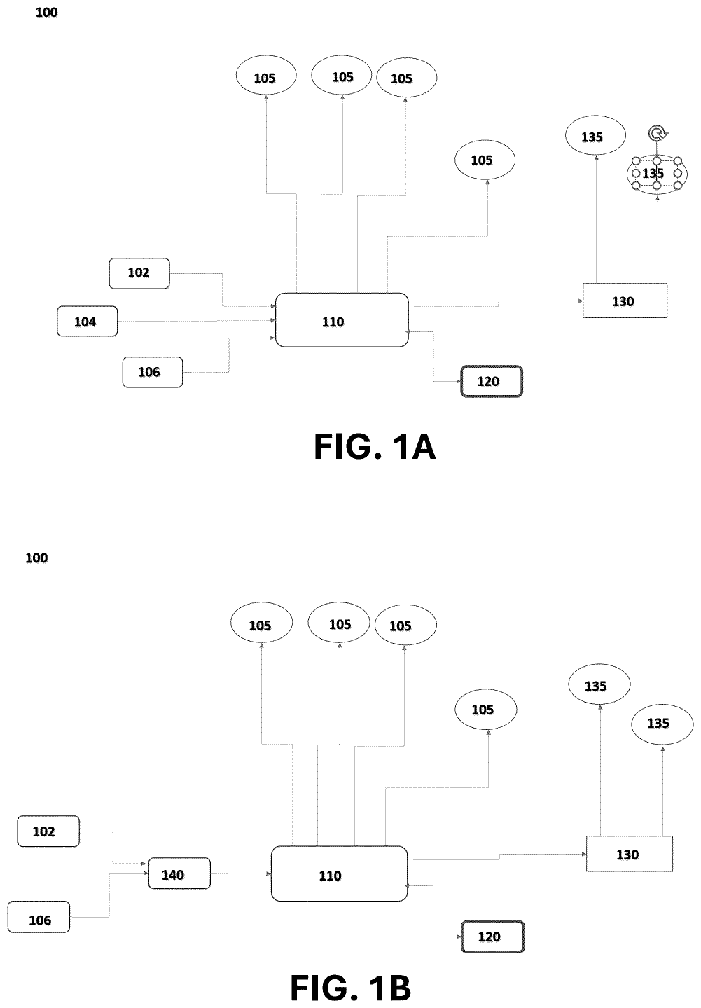

FIG. 1A, illustrates an exemplary embodiment of an integrated building design, control, and operation system 100 using a high efficiency fault managed power microgrid.

Referring to the exemplary system of FIG. 1A, power from one or more primary power sources 102, 104, 106 is provided as inputs to a first tier building power converter system 110. The first tier building power converter system 110 receives input power from one or more primary power sources and converts the received primary power into one or more fault managed power outputs which could be, for example low voltage DC outputs. (For purposes of the present disclosure a low voltage DC output is a DC output voltage where the voltage and/or power level of the DC output voltage is such that it can, consistent with applicable building codes, regulations, and protocols, be transmitted throughout a building using a power line (e.g., a conductive wire, a cable consisting of a plurality of conductive wire, a CAT6 cable or other suitable Ethernet supporting cable) without the need to position the power line within a separate conduit structure).

In the illustrated example of FIG. 1A, the first tier building power converter 110 and its components operate under the control of a main building controller 120. The main building controller 120 controls the operation of the first tier power converter 110 to initiate the provision of fault managed power to a plurality of loads 105, 135 and/or to adjust the power level provided to such loads and/or to monitor the operating characteristics of such output. The main controller 120 can also enable and perform additional functions such as metering the plug load consumed by devices connected to the system (both through monitoring the provided power and by communicating with a connected device directly) and load shedding by controlling the provision and/or operational state of one or more loads to adjust the system's overall power consumption.

As reflected in the FIG. 1A, the fault managed power provided by the main converter 110 can be provided directly to a load 105 (e.g., to a light driver, a refrigerator, a fan, a television, an AC outlet, etc.) or an intermediate controller or load driver 130 that can then provide power (e.g., AC, DC, or a form of fault managed power) to a further load 135 (such as a light fixture, etc.).

The primary power sources 102, 104 and 106 may take a variety of different forms and can include, for example: AC line power from an electrical utility; power (AC or DC) provided by a hydrocarbon powered generator; DC power provided by a battery or other energy storage system (e.g., from a flywheel or thermal storage system); power provided by an operating solar or wind generating array; and/or any other source that can provide a suitable source of AC and/or DC power. The input power provided by the primary sources can take different forms and, in one embodiment, can constitute AC power that can vary from 100 VAC to 277 VAC single phase and/or DC input power ranging from 48 VDC to 380 VDC.

The first tier building power converter 110 can likewise take many forms and will generally include one or more structures for transforming the received power from the primary power sources into one or more fault managed power outputs (such as a low voltage DC output, a high voltage DC output and/or any other form of, or combination of, suitable fault managed power output) using suitable conversion circuitry.

To the extent that it is required, the first tier building power converter 110 can additionally process the received power from the primary power sources to provide one or more non-fault managed power outputs (such as an AC voltage output) and/or provide a pass through connection to one or more of the primary power inputs 102, 104, 106.

The specific voltage and/or power level and/or form the various fault managed power output will take may vary from output to output, region and building-type to region and building-type.

The fault managed power outputs from the first tier building power converter 110 can all be at the same voltage level, can be at different voltage levels, or/or can be at levels that are subject to adjustment. They can also be the same form (e.g, low voltage or high voltage) or different forms.

Thus, for example a first group of fault managed low voltage DC outputs could all provide power at the same low voltage level. Such outputs could be used, for example, to power various low voltage lighting elements within the building to be operated only under certain conditions.

In one exemplary embodiment, the only connections required for between the first tier power converter 110 and a supported load 105 or 130 (such as a light within a room) will be a single low-voltage cable for power. In such embodiments, if data communications are desired between the main controller 120 and the load, a fiber optic cable can be run with (or as part of the same cable structure as the power line) to permit communication between the main controller 120 and one or more of the loads. Such data connections are not illustrated in FIG. 1A, but will be understood. Alternate cabling, such as CAT6 cabling can be used to enable the provision of power from the converter 110 to the loads 105, 130 and the exchange of control and communication signals from the main controller 120 to and from the loads.

In a still further embodiment, the system can be constructed such that the fault managed power outputs from the converter 110 can be run in a building without the use of conduit and still comply with all applicable building codes, regulations and practices. In such embodiments—because fiber optic cable typically does not require conduit—the connections between the main controller 120 and each supported load necessary for the provision of power can be made through relatively simple and low cost cable runs.

The elimination of the need for conduit can result in a significant cost and time savings since the material and labor costs, and construction time, required for the creation and placement of conduit runs will be unnecessary.

In the embodiment described above the primary power sources directly feed the first tier converter 110. Alternate embodiments are envisioned wherein the primary power sources initially feed a large battery storage system and the battery storage system, in turn, feed the first tier power converter. Such a system is illustrated in FIG. 1B, with the battery storage system reflected by element 140.

In the illustrated system of FIG. 1B, the battery storage system 140 can be useful for ensuring that consistent, clean power is provided to the first tier power converter and for accommodating any variances in the power provided by the primary power sources. For example, in locations where primary power (e.g., provided utility power) is subject to brown or blackout periods, or periods of unanticipated disruptions, the battery storage system can operate as a form of building-wide uninterrupted power to permit continued regular operation of the building during such conditions and/or adjusted operation to account for such variances. For example, in response to a loss or adjustment with respect to one or more primary power sources, the main controller 120 could (in anticipation of an upcoming power shortage) adjust the fault managed power outputs to reduce or eliminate unnecessary power usage by, e.g., turning off non-critical lights, dropping fan speeds, turning off aesthetic features (e.g., waterfall pumps, etc.).

Considering that many conventional devices currently operate off of plug-in AC power, and current building codes and regulations, the system of the present disclosure can also include devices for providing conventional AC power. Such AC power could be provided in one of several ways.

For example, in some embodiments, one or more AC power lines could be routed through a building in conduit using traditional practices in conjunction with the fault managed power grid connections discussed above.

In other embodiments, the load powered by fault managed power line can be provided to a load in the form of a converter/inverter that converts the received fault managed power into AC power suitable for powering a conventional AC load. In these embodiments a harness constructed in accordance with the teachings of the present disclosure can be utilized where AC power is required with the harness comprising one or more linked DC-AC converters that convert the provided fault managed power to AC power Each AC outlet could be provided with its own associated converter, or one converter could be used to provide AC power for a plurality of AC outlets.

In these, and alternative embodiments, the loads powered by a fault managed power line can take the form of an appliance, device or component specifically designed or modified to operate from fault managed power.

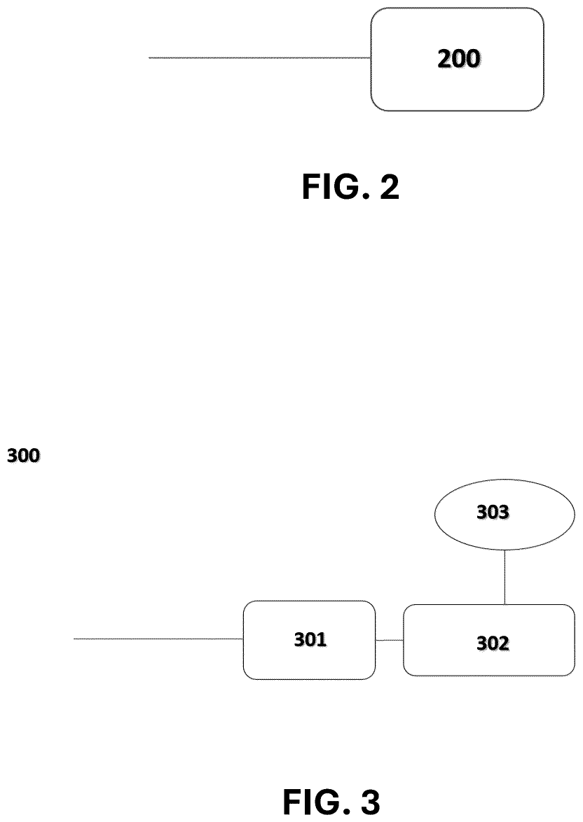

For example, conventional televisions are typically designed to receive power via an AC power cord that is internally converted to various AC and DC voltage levels for powering the electronics necessary for proper functioning of the TV. Conventional TVs also are typically designed to receive data and/or transmission signals via one or more of a coaxial cable, a wired connection (e.g., an Ethernet, USB and/or HDMI connection) and/or an antenna connection. As such they are not optimized for use in efficient low DC voltage power grids. FIG. 2 illustrates an example of an alternative television device 200, constructed in accordance with teachings of the present disclosure, suitable for use in a fault managed power microgrid as described herein. In the specific example discussed herein, the television will be described as receiving fault managed power in the form of low voltage DC power (which could be POE power). It will be understood that the applied power could be any form of fault managed power.

Referring to FIG. 2, the low voltage DC grid television 200 includes a screen, a cabinet and many of the basic electronic components found in a conventional television. However in the illustrated embodiment, the power provided to the TV, and the data, control and programming information provided to the TV is accomplished via the use of a single low DC voltage power/data input comprising, in one example, a CAT6 connection where one or more lines within the CAT6 assembly is used to provide low voltage DC power as described above, and one or more of the remaining lines is used to provide data, control and/or programming information to the device.

Internally, the television 200 will include suitable power conversion circuitry for converting the received low voltage DC power from a dedicated or intermediate grid transport line as described above.

Alternate embodiments are envisioned wherein the CAT6 connection is replaced with a connection consisting of an optical fiber connection for the provision of data, control, and/or programming information to the device 700 and one or more lines are provided (e.g., two copper lines carrying low voltage DC) are used to deliver power to the TV.

Still alternate embodiments are envisioned where the same line/lines used to deliver low voltage DC power are used (e.g., by an overlayed signal and/or through modulation of the low voltage DC pulses) data, control, or programming information to the TV 700.

While FIG. 2 illustrates a television designed for optimized use within a low voltage DC power grid, it will be appreciated that other devices that typically operate using provided AC power could likewise be modified to operate from provided fault managed power and/or fault managed power in conjunction with a data and/or control feed. Such other devices could include microwave ovens, refrigerators, coffee makers, irons, and hair dryers.

For certain devices, e.g., tea kettles, irons, and some hair dryers, high initial or running starting current may be required that is not easily obtained through the provision and conversion of certain forms of fault managed power, such as low voltage DC power. For such devices, a low voltage DC power storage/converter 300, such as the one illustrated in FIG. 3 may be used.

Such an apparatus includes an input module 301 that receives the fault managed power and that can convert the received into a power form that may be stored in a battery module 302 comprising one or more batteries. The output form the battery module 302 can then be provided to a load 303, either as a DC output from the battery module or as a converted AC output. Through the use of the local battery module 302, additional local current capability can be provided to meet local current needs.

The input model 301 in the example set out above may also be coupled to a data line such that it can communicate its status to the main central controller 120.

Embodiments are envisioned where there is no data connection and the battery is maintained at a desired storage level whenever coupled to fault managed power. Embodiments when there is no data connection are also envisioned wherein the main central controller will decide whether to send power through the microgrid transmission line/lines powering the module 301 based on various factors including whether the device is on a floor (or in a room) that is occupied or anticipated to be occupied and/or whether the time of day is one that would warrant full storage in the battery module. In this manner power can be conserved.

Still alternate embodiments are envisioned wherein a data connection exists and communication from the input device 301 to the main central controller determines whether and when power is applied to the microgrid transmission device main central controller when its power is low and request charging power. Alternatively or additionally, the input device 301 could be coupled to a proximity sensor and request charging and/or operating power whenever a potential user is detected in the vicinity of the device.

In some embodiments, the structure 300 as described above can be physically associated with a particular appliance, such as a tea kettle, and can be integrated into the kettle. In others, the structure 300 can be stand alone with ports enabling a connection between the device to be powered and the storage/converter device 300. In still other embodiments, the structure 300 (whether integrated with an appliance or not) can include additional power conversion circuitry to provide an AC outlet or an electronics charging outlet (such as a USB outlet).

The disclosed system can be particularly useful in the efficient operation of fan and HVAC systems within a building. Such a utilization of the disclosed system can be of particular benefit since HVAC systems typically comprise a large portion of a buildings energy usage profile.

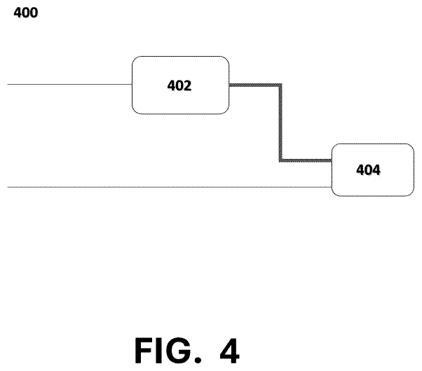

FIG. 4 depicts a high level representation of a variable refrigerant flow (VFR) heating/cooling system 400 that includes at least a compressor component 402 and a fan/cooling component 404. In the illustrated example, the compressor component 402 includes variable speed motor that, depending on the manner of energization can be operated at variable speeds to provide variable refrigerant flow to the fan/cooling component 404. In the example, both the compressor component 402 and the fan/cooling component receive fault managed power (such as POE power) from the first tier converter. While not necessary, each component may also include a data link to/from the main controller. As one example a CAT6 connection would be used to provide the power, data, and control connections for the components.

In one embodiment one or more of the described VFR HVAC systems could be provided throughout a building. For example one could be utilized in each room of a hotel and one or more others could be used in various spaces of the hotel. In such an embodiment the main controller could activate one or both of the components 402 and 404 (or not) to effectively and efficiently control the environmental conditions for the building and/or balance the load demands placed on building equipment.

For example, in one embodiment, the main controller could control the activation of various HVAC systems to ensure that rooms that are occupied are cooled, but that rooms that are not occupied are not cooled. Additionally or alternatively, the main controller could maintain rooms identified as non-occupied at a specific target temperature different from the occupied target set for such rooms. Still further, for large rooms, the controller could alternately activate different components to balance out the equipment usage among various component's.

The concept described above need not be limited to refrigeration systems and could be applied to various components with different operating states. For example, the described approach could be used to control motors with separately exercisable coils (such as an exhaust fan) to ensure that the coils of such motors are energized efficiently.

Still other embodiments are envisioned wherein the load includes a high, or variable powered, tunable lighting driver capable of powering a wide range of lighting fixtures.

In one embodiment of the present disclosure, one or more of the controllable devices described above is combined with various sensor and control elements to create a system that can be used to monitor, achieve, or balance, various target goals.

For example, embodiments of the present disclosure are envisioned wherein a programed control system is utilized to dynamically and/or continuously (or periodically) rebalance the heating, ventilation and air conditioning (HVAC) airflow with portions, or the entirety, of a building.

In addition to the fault managed power grid system and devices discussed above, the present disclosure contemplates an associated design, commissioning, and operating system (referred to herein as the DCO Assistant and designated at times as “Q”) that can be used to design and commission highly sustainable buildings and to optimally operate, manage and keep such buildings operating at a high level of efficiency through their lifetime. The disclosed DCO Assistant can provide an encompassing system for building design, construction, energy modeling, equipment lifecycle management, and tenant management.

The DCO assistant may be implemented through the use of a local, distributed, cloud-based or hybrid computing system consisting of one or more processors, with access to data, programmed to implement the functionalities and algorithms disclosed herein.

The disclosed system integrates activities previously conducted somewhat in isolation and ensures that the design of a high efficiency building meshes with the construction and operation phases of the building such that all aspects of building system design, construction, and operation operate as an integrated system.

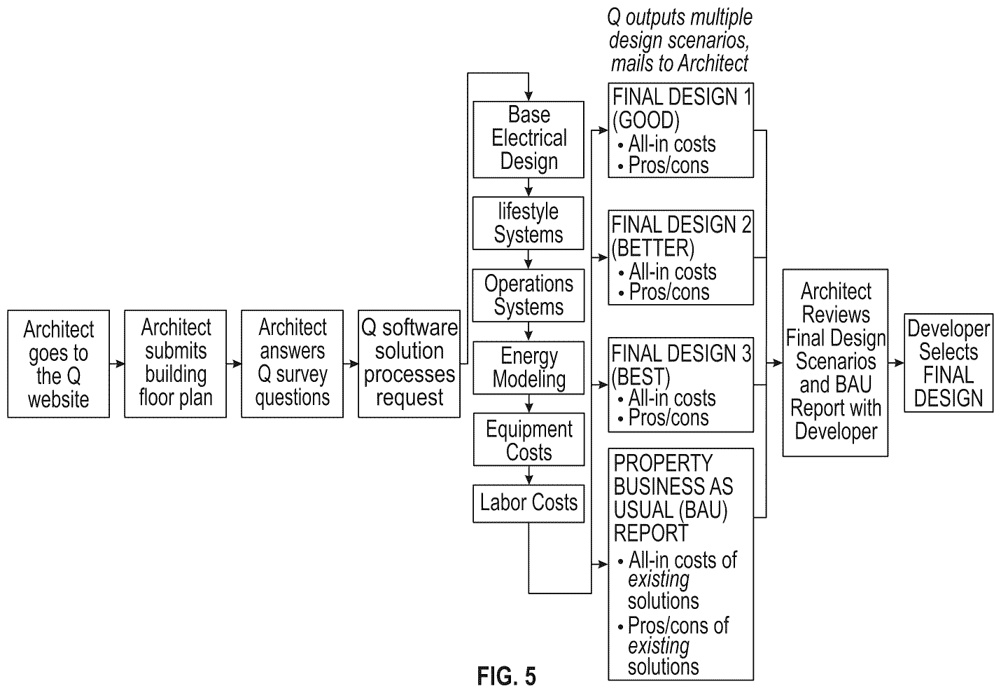

FIG. 5 illustrates certain operational aspects of the DCO Assistant described herein.

In one embodiment, the DCO Assistant includes modules that enable an architect to input floor plan designs into the system and the system can provide proposed full building designs. Upon receipt of the building floor plan, the DCO Assistant, using preprogrammed functionality that can include artificial intelligence and/or machine learning features, can generate and provide suggested optimally designed systems for, for example, the base building electrical system, and systems/features selected to meet one or more provided, suggested, or default lifestyle or operational goals.

Further, using real-time energy and economic models, equipment and labor cost databases and information, the DCO Assistant will provide for each suggested designs, information reflecting the all-in costs for the various design options, contracting the pros and cons of each, so that the developer can select the design best suited for their goals.

In one embodiment, the DCO Assistant includes a module/modules that can generate suggested electrical plans for the overall building and/or sub-regions within the building. Such plans can be used by electrical engineers to more efficiently complete and finalize the buildings electrical layout and plans.

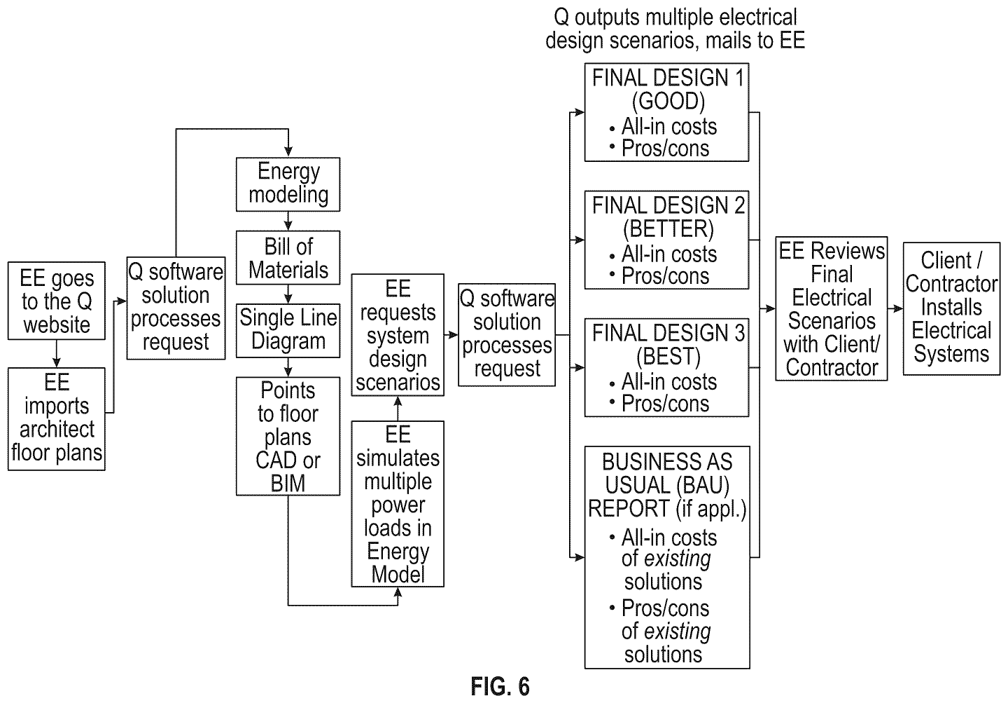

For example, as reflected in FIG. 6, in one embodiment of the DCO Assistant disclosed herein the DCO Assistant—at times designated Q—an electrical engineer can receive plans previously provided to the DCO Assistant by an architect.

In some embodiments, the DCO Assistant includes a module/modules that can, based on the input provided by architects, electrical engineers, and others generate lists and/or bills of materials with approved and/or suggested hardware, estimated costs, sources, etc. Such materials and information can be used by integrators to more efficiently select, order and obtain the elements and hardware necessary to construct, modify and/or maintain the building.

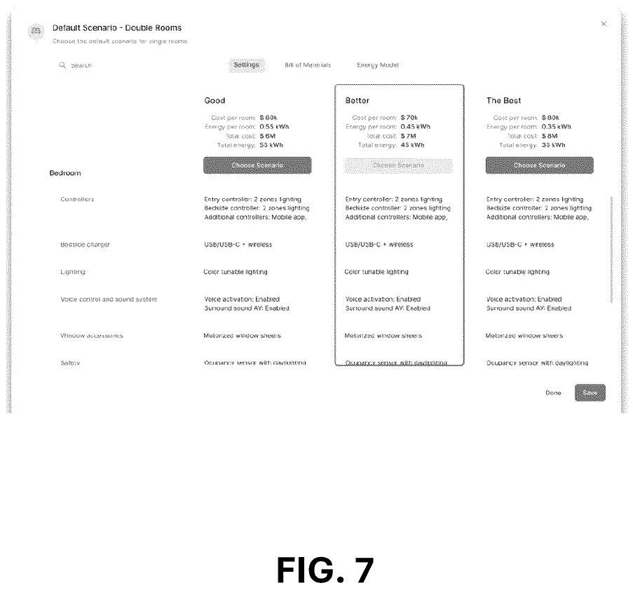

For example, during the initial construction of a building intended to be a hotel and to implement an intelligent fault managed power grid of the type disclosed above, a developer will have to decide what technology to implement on a room by room basis. For example, the designer may desire to have standard rooms have one set of features, such as a minimal level of room control in terms of the independently controllable lights and features, etc. While other, intermediate, or deluxe rooms, would have added features. Or for example, the quality of the components used in the rooms in terms of performance could vary from room to room. Still further, the base installation costs and initial energy efficiency of the various components used in the rooms could vary and be selected based on overall initial construction cost targets and/or anticipated room or building usage goals. The DCO Assistant disclosed herein can assist the developers with respect to these and other issues through the provision of information using a dashboard of the type reflected in FIG. 7.

The dashboard of FIG. 7 reflects options that a designer could select for double rooms in a hotel. Additional dashboards could be provided by the DCO Assistant for single rooms, suites, and other room configurations. As reflected in FIG. 7, the DCO Assistant can present the designer with various room-design packages (Good, Better, The Best) in the example, with each package pre-associated with bill of materials, estimated costs and estimated energy usage. The DCO Assistant can further provide information concerning the per-room costs for each package, the anticipated total building cost of certain packages, and the estimated per-room and building energy usage based on package selection.

For each of the different options provided above the DCO Assistant will have access to product databases, product specifications, wiring requirements, power requirements, API information, cost information, and alternatives associated with the various components implicated by the design. Further each room option could be associated with a wide-variety of features and components including options concerning or relating to: Automated Class IV power system Lighting; Window shading & treatment; Battery storage; Photovoltaic panels (PV); HVAC; In-Room controls (touch panels, switches, dimmers, etc.); Network connectivity; AV; Security; Access control; Cameras; Life Safety; TelCo; Device charging; AC outlets; sensors: occupancy, air quality, noise levels.

As will be appreciated, the information provided above allows a designer to quickly, and dynamically, assess the construction cost, energy usage, energy usage costs and other information associated with various design options and more quickly and more efficiently evaluate design options to select the building design package best suited for their goals. By doing this, the users of the DCO Assistant can both meet their goals and ensure that their initial (and on-going) capital expenditures are optimized.

Once a building is designed, constructed and commissioned, one or more modules within the DCO Assistant—or aspects of it—can be used by facility managers to monitor and control building behavior to better comply with the buildings energy efficiency goals, the managers power and/or profit goals, and any other target goals associated with the building. This monitoring and control will ensure proper operation of the building as per the energy model selected in the design phase and provide reports as to whether the building has and is meeting the selected design target. Further, in some embodiments, it can provide a platform for efficient replacement of failed or failing equipment throughout the building and enable the setting of additional platforms and applications to enhance tenant and/or user experience.

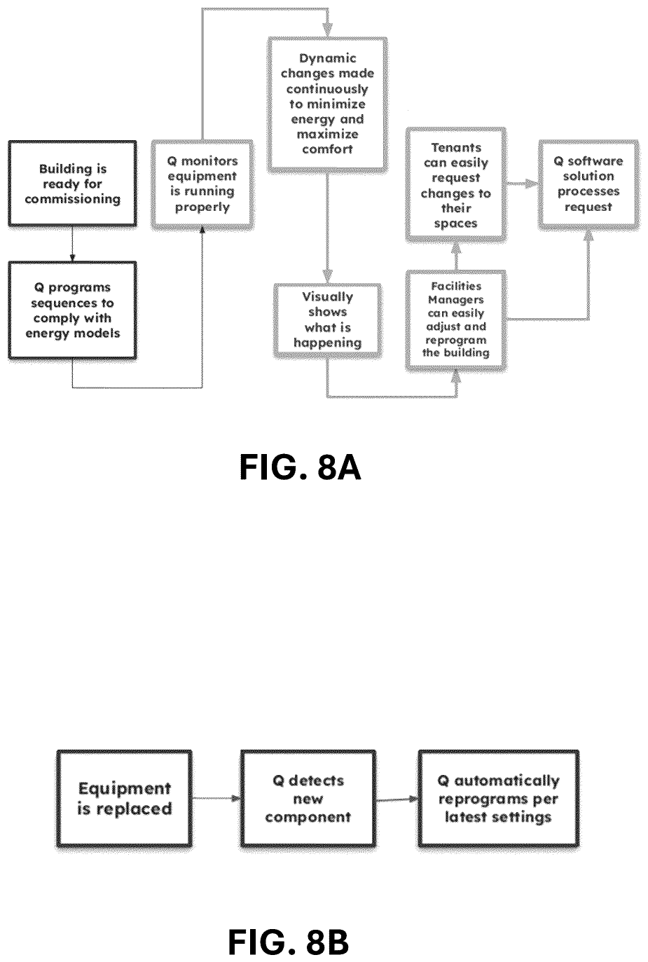

In one embodiment the DCO Assistant can be configured to assist in the commissioning of new and/or replaced equipment by including the drivers and programming necessary to integrate such equipment into the fault managed power grid and the control system implemented by a main controller. In such embodiments, the DCO Assistant can be configured to automatically identify new (or replaced) equipment, update the main controller's database to reflect such equipment and push the new equipment any configuration settings or drivers required for it to operate within the overall system. One example of such an embodiment is reflected in FIGS. 8A and 8B.

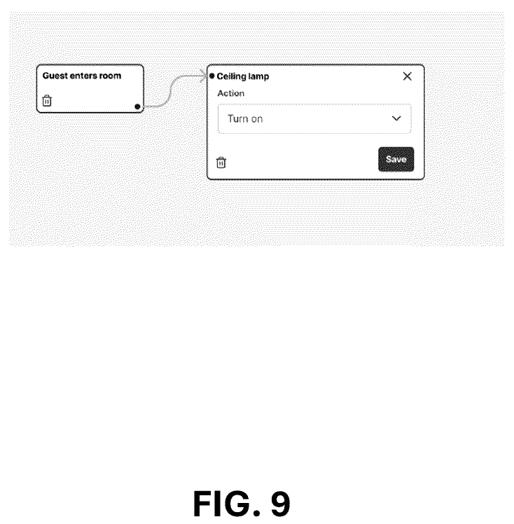

As will be appreciated, because the disclosed intelligent fault managed power grid permits power control on a gross, regional, and highly-granular level, the DCO Assistant can be used by a facility manager or operator to control aspects of building operation that can both enhance usability of the building and/or promote one or more operational goals. For example, if the building under control is a hotel or other location where human user experience is to be maximized the DCO Assistant can be set to automatically turn on a light in a room the first time (or at all times) a human is detected as entering the room (e.g., via a door sensor or a proximity sensor). In the disclosed system, this could be done efficiently through a simple programming interface such as the one depicted in FIG. 9

It will be appreciated that the example described above, is a simple one and that the system described herein can be used to implement more complicated control features. For example, in the example discussed above, the system could be modified to turn on the ceiling lamp only during periods where it would be dark outside the building, or only open the user's first entry into the room, or only when no other user is detected to be within the room, etc. Still further, it will be appreciated that a setting such as the one illustrated in FIG. 9 (i.e., turn on lamp when guest enters room) could be set by the DCO Assistant as a default setting and a user (e.g., a guest who has checked into a room) could modify the default setting either (for a hotel, for example) after checking into the room via a television interface or prior to first entering the room via a loyalty application on a cell-phone.

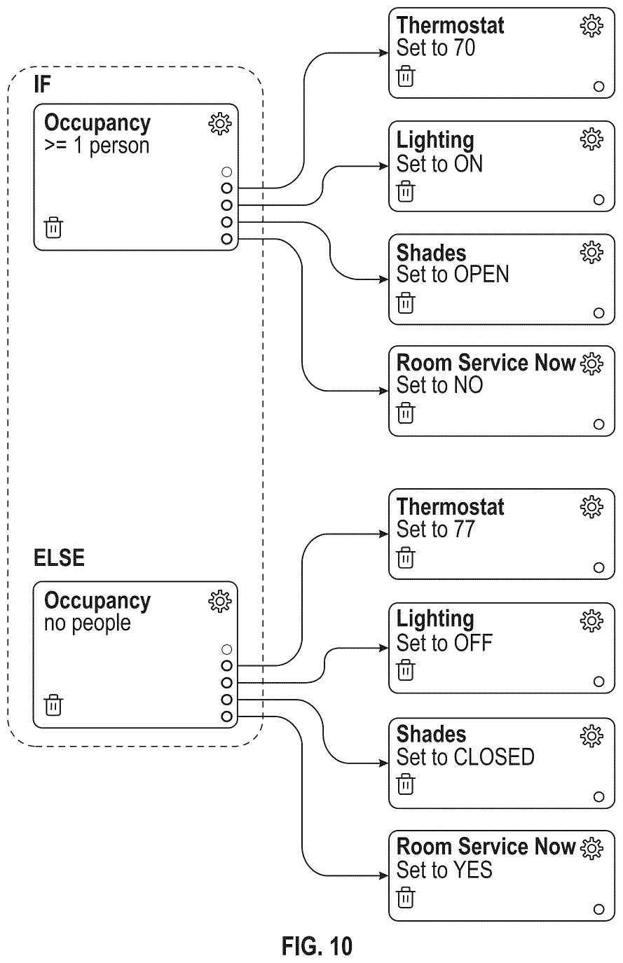

In addition to being able to enhance user experience, the DCO Assistant described herein can be used to control a building to promote efficient use of the building, and/or to reduce power consumption and, therefore, power costs. For example, as reflected in FIG. 10, in the example of a hotel, the DCO Assistant could permit the designation of some or all of the rooms in the hotel as either being occupied or unoccupied and implement control functionality based on that designation.

Thus, as shown in the example, for rooms set to occupied, the DCO Assistant could automatically set and control various conditions of the room to have a desired thermostat setpoint, a desired lighting condition, window shade condition, etc. Note that the conditions identified above could be set as default settings and that such settings could be changed. Thus, for a hotel, a guest could indicate at check-in, during the check-in process, or via a phone or computer application what conditions they would like for their room in terms of thermostat setting, shade condition, etc. and the occupied room conditions for that user could be set to those desired settings (if within the limits permitted by the DCO Assistant). For such a guest, the DCO Assistant disclosed herein could therefore provide a personalized, performance or energy efficient optimized experience.

Additionally and/or alternatively, the DCO Assistant, as disclosed herein, can be used to monitor building operations in real time and provide feedback to sustainability and other managers for purposes of verifying compliance with various sustainability goals, ESG goals, or other goals.

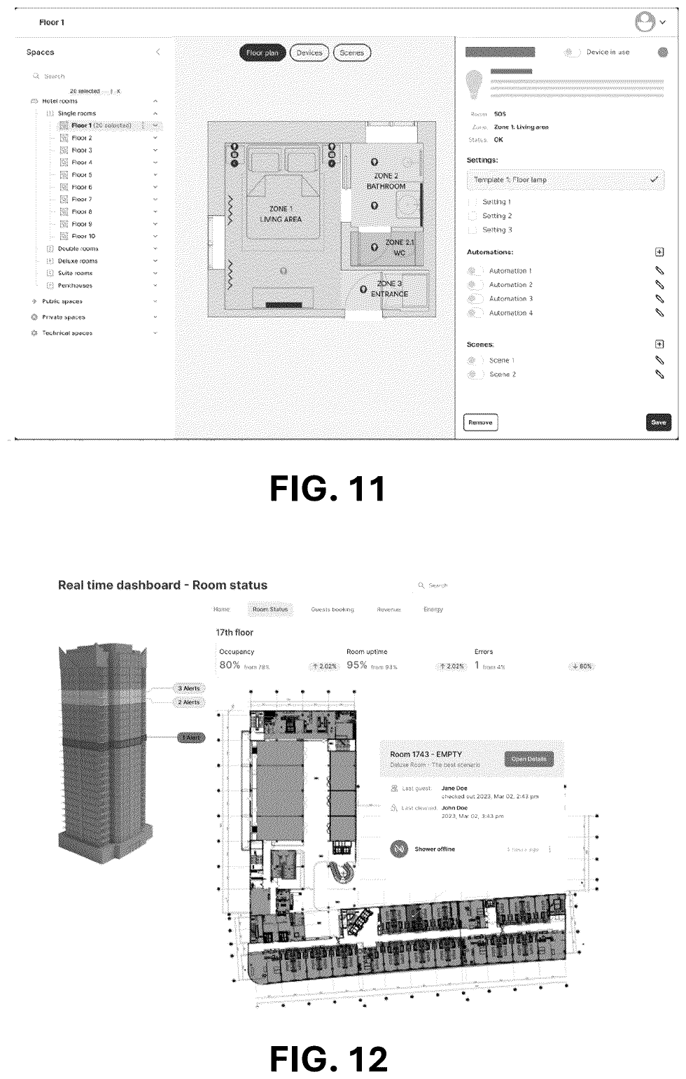

For example, for the example of a hotel, the DCO Assistant could be used to provide real time information concerning the occupancy state of the building on a floor-by-floor and a room-by-room basis. For example, for a given room the DCO Assistant could provide status information concerning the state of a given room as a whole, of zones or regions within the room (e.g., living area, bathroom, entrance, etc.). In addition to providing reporting information, the DCO Assistant could also allow for immediate adjustment of the settings associated with a given room, such as lighting, shade, sound, television, settings, etc.. An example of such a room specific monitoring dashboard as may be provided by the disclosed DCO Assistant is set forth in FIG. 11.

It could also be used to provide information of general management interest, such as whether there is an alert/alarm for a given room (e.g., service requested or an unresolved guest issue), the relative occupancy rate over a previous day/month/date by year, or specific room usage. An example of how the DCO Assistant may provide such information is shown in FIG. 12.

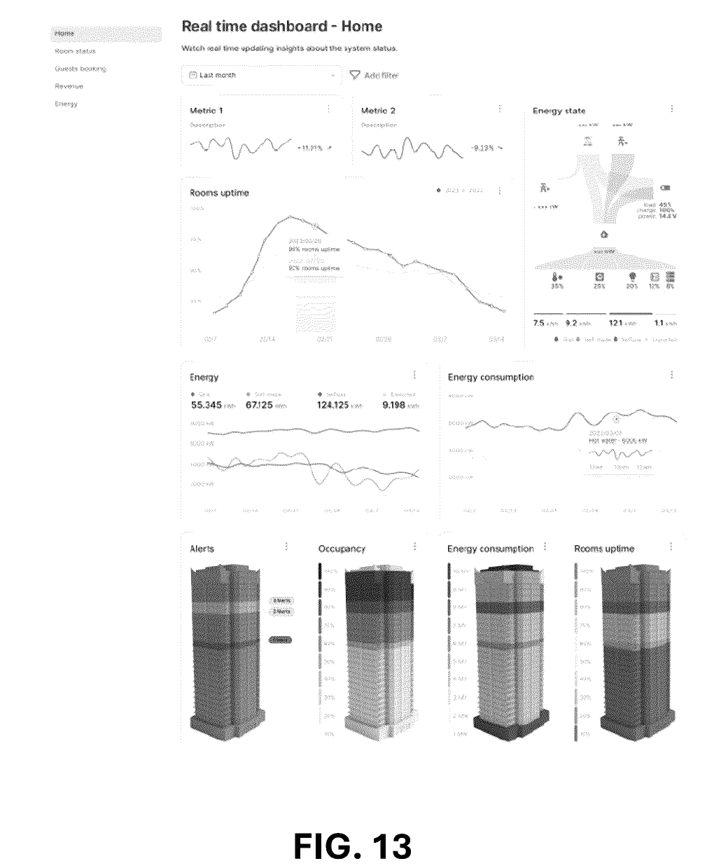

Still further, in addition to providing the current real-time information for building operation the DCO Assistant disclosed herein can be used to provide generalized data concerning the building usage, building energy efficiency, revenue efficiency, and other building parameters. For example, for the example of a hotel, the DCO Assistant could be used to track and report on a variety of different metrics such as room uptime, energy consumption, energy usage by date, etc. An exemplary DCO Assistant dashboard reflecting such information is provided in FIG. 13.

The functionality provided by the DCO Assistant disclosed herein provides building designers, operators, and users with unique opportunities to optimize their financial and operational goals.

For example, when utilized in a building operating as a hotel, the DCO Assistant can be integrated with the guest check in system to allocate rooms to minimize mechanical system utilization. Instead of checking in people all around a building, guests can be grouped to minimize the number of boilers and chillers required to run at any given time and balance out equipment run time.

Continuing with the hotel example, some of the monitoring data can be made available to guests (or tenants in an office building) to make decisions based on their personal preferences. For example, knowing if an area of the hotel (pool/gym) is busy, what the temperature at such a location is, or whether a particular location (e.g., a conference room) is warmer/colder than another (e.g., an office dining area) can allow a guest or tenant to take actions in line with their preferences.

As another example, in any building, such as an office, the DCO Assistant can be used to establish settings that define how occupied and unoccupied spaces perform, including checks to ensure that overrides and schedule changes don't result in excess costs or wasted energy.

The following examples, illustrate scenarios reflecting how the DCO Assistant disclosed herein can be used and/or provide information to optimize building design, construction and/or operation:

EXAMPLE: Frances is an architect that starts a design process using the DCO Assistant disclosed herein. She uploads a Revit model of the building and answers a brief survey of the project goals by explaining it is a net-zero luxury hotel, the lat/long of the lot, special features and amenities of the building, etc. By processing the RevIt model the software calculates the power requirements for the entire project. Then it designs the end-to-end Class IV power systems required for the DC microgrid within the building from base building devices all the way to in-room devices, including solar PV calculations and battery storage options. Using the Sinclair Philosophy database, it runs multiple databases on different approaches to buildings, doing the designs for each approach by picking all devices through end devices (i.e.: televisions, Wi-Fi access points, minibar refrigerators, light switches, in-wall touch panels, and more). For each scenario it generates an energy model and a bill of materials with labor pricing. Once complete, Frances receives high level summaries of each system with overall carbon footprint, embodied carbon, cost numbers, and specification sheets, showing the portfolio of products and applications available for each scenario.

EXAMPLE: William is a 6′7″ 26-year-old professional sprinter who trains daily and is sponsored by a sustainability company. While staying at a hotel he wants to minimize his carbon footprint and use the gym. He's most excited about staying at Hotel because:
When he checks in, the hotel automatically books him on a floor that is mostly occupied, thereby reducing his overall carbon footprint by taking advantage of shared heating/cooling systems that are already running for other guests;
When he is on property, his room automatically configures itself to the lighting and temperature setpoints that the app has learned about him from past stays;
When he leaves the property, his room automatically enters hibernation mode to reduce energy use. It also signals housekeeping that he is gone since he appreciates privacy;

Through the DCO Assistant disclosed herein app on his phone, William constantly checks hotel space usage rates, especially at the gym and at the pool. He wants to ensure that there is room for him to do his workouts. He overlays air quality data from those spaces to make sure he is setting his workout up for success. Since the pool is busy, he registers for a notification to alert him when space opens up for him.
After his workout, he wants a beach chair in full sun. He puts in his request and the system will automatically notify the cabana to reserve the next available pool chair while William is working out.

During checkout, William receives a report showing exactly how much energy he used during his stay, what his carbon footprint was, and what actions the DCO Assistant disclosed herein took to mitigate his footprint. With his permission it automatically posts on social media about it.

EXAMPLE: Keith is a 45-year old life-long facility operator. He has worked in a class A office building and two luxury hotels. He has an obsession for vintage cars and making sure they are always running optimally. He brings that same attention to detail to his buildings. On the weekends he wants to enjoy driving his 1957 Chevrolet Corvette convertible and not worry about systems at work. Using the disclosed DCO Assistant, Keith knows that his hotel is going to run at optimal efficiency because he's activated these features:
The guest check-in system allocates rooms to minimize mechanical system utilization. Instead of checking in people all around the building, it groups them to minimize the number of boilers and chillers required to run and to also balance out equipment run time.
The system interface shows how the hotel systems are being used and which areas are not performing as dictated by the energy model or areas that are not meeting the guests' personal preferences that the DCO Assistant disclosed herein has learned. Areas that have discrepancies will attempt a series of automated actions to remedy the discrepancy condition. Whether successful or not, Keith will get a notification updating him of the issue and the outcome.
If a device goes offline, for example in-ceiling lighting in a guest room or AV equipment in a conference room, the DCO Assistant disclosed herein will automatically take steps to reboot the devices and remedy the situation. In the event equipment is broken and requires replacement, hotel staff can simply swap the broken device with a replacement and the DCO Assistant disclosed herein will automatically reprogram and commission the device reducing the number of workers and time required to resolve the issue.
Every guest room, conference room, and amenity space will automatically adapt itself to occupied and unoccupied modes based on predefined rules. Those rules, even if overridden, will automatically kick back into effect after a certain amount of time so he doesn't worry that someone turned off energy efficiencies for weeks or months.
Every month the DCO Assistant disclosed herein will generate the local government required energy reports and corporate energy reports automatically.

EXAMPLE: Kirsten is a 51 year old electrical engineer that has been designing buildings for over twenty years, she owns her firm and has 20 engineers working for her. She has become interested in DC-powered buildings but is concerned the technology isn't ready for prime time use. However, at her home she does have solar panels with a battery system and believes her electric bill can be reduced 30+% by eliminating the DC-to-AC transformation phase.

Using the disclosed DCO Assistant, Kirsten, and all of her employees, is starting design on a new hospitality project and can:
Import architect-supplied floor plans into the DCO Assistant disclosed herein that trigger the automatic generation of the entire in-building electrical system design where the design will include an energy model, a bill of materials, a single line diagram, points added to the floor plans in CAD or BIM.
Simulate different power loads in the building, for example allocating more than the code required amount of power to each hotel room. This simulation tool will allow her to confirm the system has enough extra capacity in case the use case changes.

EXAMPLE: The DCO Assistant generated energy model will also have sequences and programming of key systems in the building with the ability to change behavior and see what impact it has on energy usage. For example, changing the default “away” thermostat setpoints and lighting level in unoccupied areas of the building to see what effect it has on the energy use.

The DCO Assistant will display a few alternative system design scenarios that contrast different energy usage levels and system cost so that Kirsten can review, and even offer to her client, alternatives and discuss their tradeoffs. For example, her project might be in a very cold climate and the system decides it is better to keep all unoccupied spaces at the “occupied” setpoint because it will take too long to heat when a guest checks in, or perhaps the energy costs may actually be higher to reheat a cold space than maintaining an already heated space.

EXAMPLE: Greg is a Warehouse Owner who already has the DCO Assistant disclosed herein installed in his large distribution center. Greg's key interests are optimizing energy consumption wherever possible and maintaining a productive work environment that facilitates workflow.

Greg can use DCO Assistant disclosed hereinto optimize the temperature and lighting to minimize energy consumption for different use cases:
Heating/cooling settings for when the warehouse is staffed and operational (manual overrides available)
No heating/cooling for after-hours/skeleton crew shifts (manual overrides available)
Preferred heating/cooling levels for specific warehouse areas (cold chain of custody, etc.).

The disclosed DCO Assistant can also help Greg determine space utilization by recording areas with the most activity via heat maps. His interest is to optimize floorspace and workflow, with the goal of ensuring commonly used inventory is most accessible while lesser-used inventory is placed in the further reaches of the building. Doing so decreases pull times, reduces machinery wear and tear, and lowers safety risk.

EXAMPLE: Charlotte is a sustainability manager for a hospitality company. She needs to produce the proper reports for her firm's annual ESG report. This is important because the hospitality industry markets itself as environmentally conscious to its current and prospective guests.

Charlotte needs reporting data (and user-friendly dashboards) that compare:
A property's energy consumption year-over year
A property's energy consumption month-to-month
Prior consumption levels to the prior system's baseline expenditures, per property.
Prior consumption levels to the prior system's for the company as a whole year-over year
compare prior consumption levels for the company month-to-month.
A report depicting amount of renewable energy used versus fossil fuel energy
Share her hotel's/clients' carbon footprint reduction on social media

Charlotte can then supply the data and significance to Marketing so the message is told on social media, at industry events, and on collateral materials. Sr. Management reads Charlotte's ESG report and notices their ESG investment is creating new brand equity, lowering costs, and most importantly, bringing in new guests.

EXAMPLE: Karim owns a 50-year-old luxury hotel in San Diego. The hotel is to be renovated for a much-needed modernization. Karim must decide whether it is worth ripping out all of the existing electrical infrastructure and starting from scratch, or reusing some of the core, unchanged electrical panels in the building.

The DCO Assistant disclosed herein can divide the proposed renovation efforts into discrete projects, estimating installation time and energy consumption decreases. Additionally, the DCO Assistant disclosed herein can also calculate a business as usual (BAU) report for existing solutions in the building. So Karim can create models contrasting a full renovation vs partial renovations.

In this case, using the DCO Assistant, he can create reports for renovating just the lighting systems, just renovating the HVAC system, or renovating both. The report shows a 40+year ROI for HVAC but a 5+ROI for lighting. The UAE report also shows much cheaper HVAC expenses as well.

In the end, he can decide to keep the HVAC system in place and renovate the lighting system bed on the DCO Assistants indication that the lighting renovation is an easier effort with a shorter payback period. Additionally, Karim can note that the hotel is in a very temperate climate (San Diego) and HVAC renovation is not a ‘visible’ improvement customers will appreciate or notice (unless there's an outage). However, the lighting renovation is very noticeable, takes less time to install, and provides a ‘new look’ to the old hotel that the owner can show people. Thus providing an opportunity to convince others that a historic hotel can be more ecologically responsible than most modern ‘new’ hotels.

As will be appreciated, through use of the DCO Assistant operating features disclosed herein, a building manager can lower their operating expenditures by automating cost-control modes to decrease electrical consumption when rooms are unoccupied or vacant. They can further, simultaneously, improve the experience/happiness of those using the building and its features by reducing service outages, ensuring consistent facility operation, and customizing the user experience to the specific desires of a given user.

Other and further embodiments utilizing one or more aspects of the inventions described above can be devised without departing from the spirit of Applicant's invention. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

1. An integrated building design, control, and operation system using a high efficiency fault managed power microgrid comprising:
a first tier building power converter system that receives input power from one or more primary power sources and converts the received primary power into one or more fault managed power outputs;
a plurality of loads, each load coupled to receive one of the fault managed power outputs; and
a main building controller in communication with the first tier building converter system and configured to control the operation of the first tier power converter to initiate the provision of fault managed power to the plurality of loads and/or to adjust the power level provided to such loads and/or to monitor the operating characteristics of the outputs;
wherein at least one of the loads powered by one of the fault managed power outputs comprises a harness and one or more linked DC-AC converters that convert the provided fault managed power to AC power, were each DC-AC converter is associated with an AC outlet.

2. The system of claim 1 wherein at least one of the fault manager power output is a low voltage DC output that can be transmitted using an Ethernet supporting cable without the need for a separate conduit structure.

3. The system of claim 1 wherein at least one of the loads is a television that receives power, data, control, and programming information through one of the fault managed power outputs.

4. The system of claim 1 wherein at least one of the loads includes an input module that receives fault managed power and converts the received power into a power form that may be stored in a battery module; and a battery module comprising one or more batteries for storing the converted power, wherein the battery is capable of providing a current output greater than the current output of the first tier building power converter system.
